(19) United States
(12) Patent Application Publication
(10) Pub. No.: US 2004/0075187 A1
(43) Pub. Date: Apr. 22, 2004

(54) Method and system for fabricating elastomeric compounds

(76) Inventor: James Louis Christie, Landenberg, PA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 10/271,737

(22) Filed: Oct. 17, 2002

(51) Int. Cl. B29C 47/38

(52) U.S. Cl. 264/141; 264/211; 264/211.21; 425/202; 425/205

(57) ABSTRACT

A method and system (10) of fabricating elastomeric compounds is provided. The method includes the steps of establishing a thermo-kinetically heated high speed mixer (100) and introducing into that high speed mixer (100) in predetermined quantities a comminuted rubber composition (110), a plasticizing agent composition (120), and at least one additive composition (130, 132, 134). The method includes the further step of simultaneously mixing and thermo-kinetically heating the comminuted rubber (110), plasticizing agent (120), and additive compositions (130, 132, 134) in the high speed mixer (100) for a predetermined residence time period to form a first intermediate mixture composition. The first intermediate mixture composition contains a substantially homogenous mixture of the comminuted rubber (110), plasticizing agent (120), and additive compositions (130, 132, 134). The first intermediate mixture composition is introduced with a plastic composition into a heated multi-stage extruder (500) to form a second intermediate mixture composition extrusively shaped to a predetermined sectional contour. The second intermediate mixture composition is thereafter dried to form an elastomeric compound.

### BACKGROUND OF THE INVENTION

1. Field of the Invention

The subject method and system for fabricating elastomeric compounds is generally directed to the fabrication of materials from scrap or waste rubber and plastic compositions, and certain selected additive compositions. More specifically, the subject method and system is directed to the simple yet highly efficient fabrication of elastomeric compounds usable as stock materials in subsequent processes to form various elastomeric products.

The ever-growing need to productively re-use scrap or recycled waste materials has fueled the development of processes whereby scrap or recycled rubber-containing materials are used in the fabrication of other useful products. Unlike many other scrap or recycled materials which often find use as nothing more than bulk fillers, scrap or recycled rubber-containing materials such as “crumb rubber” (comminuted form of recycled vulcanized rubber tire materials) are peculiarly suited for use in the fabrication of products having useful elastomeric properties. In most applications, however, the scrap/recycled rubber-containing material cannot be utilized very productively unless it is first compounded with certain other compositions so as to exhibit a suitable degree of homogeneity. Without the requisite homogeneity of compounded mixture, desirable combinations of material properties cannot be consistently realized.

Elaborate processes have been developed, as a result, to obtain the degree of homogenous compounding necessary. As useful and effective as these processes have been, they are found to be much too time-consuming and inefficient to be practicable for a wide range of applications. The incentive to re-use scrap or recycled materials, for many users, lies as much in the cost savings, as in the general environmental benefits derived from such re-use. Where the additional time consumption and process inefficiencies due to the re-use are great enough, the costs of so re-using scrap/recycled materials could conceivably approach and even exceed the costs of wholly reconstituting the rubber material. The incentive to re-use scrap/recycled materials is largely lost in those instances.

There is, therefore, a need for a process and method by which scrap or recycled rubber materials may be compounded with other compositions to a sufficiently homogeneous mixture to yield a suitable elastomeric compound. There is a need, moreover, for such a process that carries out the compounding with sufficient speed and efficiency to preserve the cost effectiveness of re-using scrap or waste rubber materials.

2. Prior Art

Methods for producing elastomeric compounds from rubber compositions are known. One such method is that shown in U.S. Pat. No. 5,114,648 issued to Kuc, Sr. While the process does seek a homogeneously mixed compounding of materials, the process disclosed in that reference is limited in its ability to effect the compounding with the level of speed and efficiency sought in certain applications. There remains a need for a method and system that compounds a plurality of compositions with a rubber composition, and does so in such quick and efficient manner as to enable a rate of fabrication attained by methods and systems heretofore known.

### SUMMARY OF THE INVENTION

A primary object of the present invention is to provide a method and system for fabricating elastomeric compounds which effect highly homogeneous compounding of scrap or recycle rubber-containing materials with certain other material components.

Another object of the present invention is to provide a method and system for fabricating elastomeric compounds which effect a highly homogeneous compounding of a scrap or recycled rubber-containing material with certain other material components, and does so in rapid and efficient manner.

It is yet another object of the present invention to provide a method and system for fabricating elastomeric compounds using scrap or recycled rubber-containing materials that remain cost effective in a wide range of applications.

These and other objects are attained in the subject method and system for fabricating elastomeric compounds. The subject method comprises the steps of establishing a thermo-kinetically heated high speed mixer, and introducing into that high speed mixer in predetermined quantities a comminuted rubber composition, a plasticizing agent composition, and at least one additive composition. The compositions are simultaneously mixed and thermo-kinetically heated in the high speed mixer for a predetermined residence time to form a first intermediate mixture composition which contains a substantially homogeneous mixture of the comminuted rubber, plasticizing agent, and additive compositions. The first intermediate mixture composition is then introduced with a plastic composition into a heated multi-stage extruder to form a second intermediate mixture composition. The second intermediate mixture composition is then dried to form an elastomeric compound.

A system effectuating the subject method generally comprises a high speed mixer operable to simultaneously mix and thermo-kinetically heat a plurality of compositions introduced therein. The high speed mixer includes a housing defining a mixing chamber, an angularly displaceable shaft coupled to the housing to extend axially in the mixing chamber, and a plurality of mixing members coupled to the shaft to extend radially therefrom. Sources are coupled to the high speed mixer for respectively introducing into that high speed mixture in sufficient contemporaneous manner predetermined quantities of a comminuted rubber composition, a plasticizing agent composition, and at least one additive composition, whereby the high speed mixer is operable to generate a first intermediate mixture composition containing a substantially homogenous mixture of the comminuted rubber, plasticizing agent, and additive compositions. The system also comprises a heated multi-stage extruder having an angularly displaceable screw feed member extending axially through a plurality of sequentially disposed heating stages. A source is operably coupled to the extruder for feeding a plastic composition at a preselected one of the extruder's heating stages. A side draft feeder is operably coupled to the extruder for feeding the first intermediate mixture composition at one of the extruder's heating stages disposed downstream relative to the preselected heating stage, whereby the extruder is operable to generate a second intermediate mixture composition. A pelletizer is operably coupled to the extruder for cooling and cutting the second intermediate mixture composition into a pelletized configuration.

### BRIEF DESCRIPTION OF THE DRAWINGS

FIG. 1 is a schematic diagram illustrating an exemplary embodiment of the present invention; and,

FIG. 2 is a perspective view, partially cut away, illustrating an exemplary implementation of one portion of an exemplary system embodiment of the present invention.

### DETAILED DESCRIPTION OF THE PREFERRED EMBODIMENTS

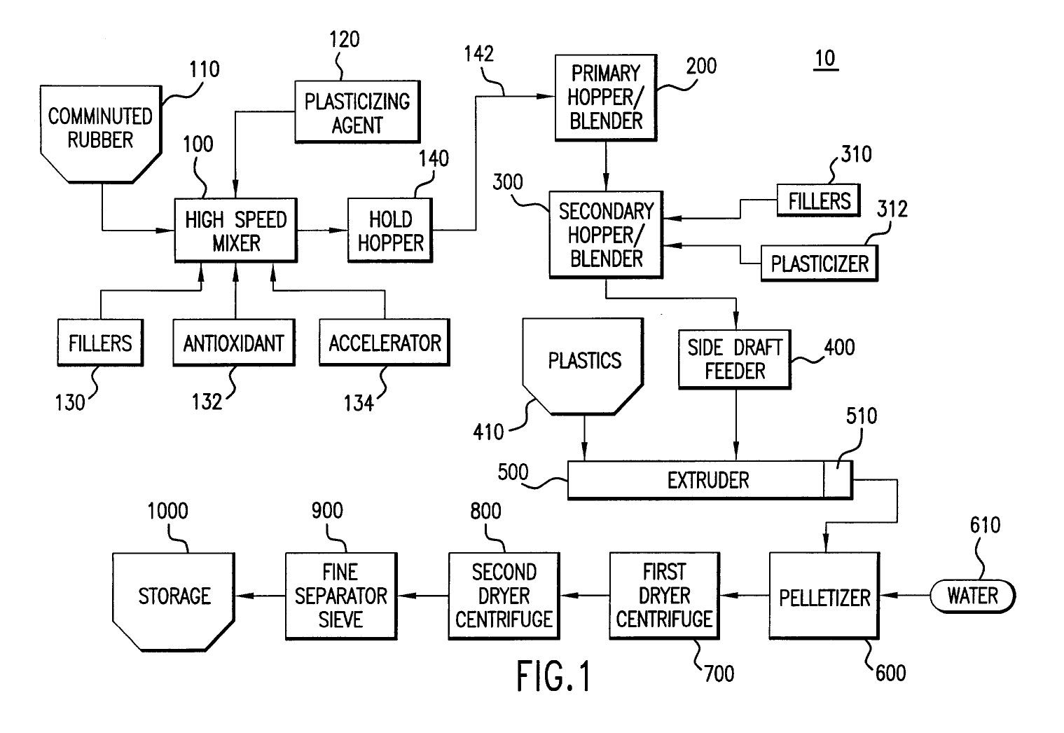

Referring now to FIG. 1, there is shown in schematic form an exemplary embodiment of the subject method of fabricating elastomeric compounds, as implemented in an exemplary system embodiment 10. Preferably, system 10 processes crumb rubber or other such comminuted form of scrapped or recycled rubber-containing materials with a plurality of additional compositions to formulate an elastomeric compound—preferably, though not necessarily, in pelletized form—having certain pre-specified material properties. The pelletized elastomeric compounds may then be used as raw stock materials in other subsequent processes to form elastomeric products of various types.

Such particularities as the elastomeric compounds' material properties, pellet configuration, and the like are determined by the specific requirements of the intended application; however, the elastomeric compounds are necessarily formed in each instance with substantial homogeneity of mixture, at least as to those components of measurable consequence to the elastomeric compounds' material properties. As a result, the individual elastomeric compound pellets yielded by system 10 are highly consistent in their makeup and therefore highly uniform in the properties they exhibit.

In prior art processes heretofore known, suitably mixed compounding of comminuted rubber and other component materials is effected only through a series of incremental processing steps carried out in time-displaced sequential manner. Typically, scrap or recycled rubber materials like vulcanized rubber from spent and discarded tires possess such material properties that they are normally resistant to compounding with other compositions, let alone to compounding in an evenly distributed, homogenous mixture with those other components. Unless the appropriate pre-treatment, heating, material introduction, mastication, and other such steps in prior art processes are carried out in carefully sequenced and precisely controlled manner, the rubber materials remain inadequately mixed with the additive materials introduced thereto. What mixing does occur in those cases, often occurs only spottily, yielding an inconsistent, unevenly combined composition which finds little, if any, productive use in forming elastomeric goods.

For any degree of homogeneity of mixture in the resulting composition, even the quickest of prior art processes typically consume on the order of approximately fifteen minutes for batch quantities of, say, 25-100 liters. Lesser processing times are obtained invariably at the cost of substantially diminished homogeneity. The present invention is not necessarily limited to batch-type processing; however, processing time is, in accordance with one aspect of the present invention, substantially reduced for comparable batch quantities to well under a minute in most applications.

Referring now to FIG. 1, there is shown a schematic diagram illustrating an exemplary system embodiment 10 of the present invention. System 10 generally includes a thermo-kinetically heated high speed mixer 100 into which a number of compositions are introduced in substantially contemporaneous manner. A comminuted rubber composition 110 containing in the exemplary embodiment shown a vulcanized rubber material recycled from discarded passenger and truck tires is introduced as the main component. A plasticizing agent composition 120 is also introduced to suitably plasticize the comminuted rubber composition during mixing and mastication within high speed mixer 100.

In addition, one or more additive compositions such as fillers 130, antioxidants 132, and accelerators 134, provide certain qualities and properties required of the resulting mixture in the intended application.

Plasticizing agent composition 120 may be any suitable composition known in the art capable of sufficiently plasticizing rubber composition 110 given specific operating conditions of the particular application. In the embodiment shown, plasticizing agent composition 120 preferably includes a highly aromatic composition made commercially available in the art under the name, TYRSOLV, by Duroplas Corporation of North East, Md., having a specific gravity of approximately 1.0 and an evaporation rate on the order of approximately 10³ times less than that of ethyl ether. In other embodiments and applications, plasticizing agent composition 120 may include other such compositions having vapor densities between 3.0-8.0 and boiling points between 500°-1000° F. Plasticizing agent composition 120 is preferably introduced into high speed mixer 100 at a temperature of approximately 70° C.

The types of additive compositions 130, 132, 134 shown for the present embodiment are only exemplary; and, in other applications, one or more additive compositions of these or any other suitable type known in the art may be introduced into high speed mixer 100, depending on the specific requirements of those other applications. Fillers 130 serve to augment the strength and volume of the intermediate mixture composition resulting from high speed mixer 100. Preferably, inert materials such as clay, barium sulfide, calcium carbonate, talc, and the like may be introduced to, among other things, enhance tensile strength in the resulting mixture.

Antioxidants 132 serve primarily to enhance the resistance of the intermediate mixture composition to oxidation when subjected to thermal extremes encountered during current or future processing steps. Antioxidants 132 thus inhibit the burning or scorching of material that might otherwise occur during processing, thereby rendering the resulting mixture more processable.

Accelerators 134 are oxidizers that serve to increase the cure rate of the resulting mixture. Formed by any suitable composition known in the art, they operate to ensure the structural soundness of the composition ultimately yielded by system 10.

Preferably, the relative quantities in which compositions 110, 120, 130, 132, 134 are introduced into high speed mixer 100 is determined by the specific requirements of the intended application. In the present embodiment, the end product is a pelletized material that may be stored in dry form then used as raw material later in formulating various elastomeric goods. For a standard weight of comminuted rubber composition 110, compositions 120, 130, 132, 134 are preferably introduced with the following approximate weight percentages: plasticizing agent composition 120 at 1% or less; fillers 130 at 1%-25%; antioxidants 132 at 0.25%-1.0%; and, accelerators 134 at 0.01%-1%. Of course, these approximate weight percentages are subject to change with such factors as the specific choice of materials for the various compositions, the addition or subtraction of one or more additive composition types, the particular specifications of high speed mixer 100, and the like. Each composition is introduced using a precise feeder capable of controlling the feed amount with sufficient accuracy to preserve the desired weight percentages.

High speed mixer 100 may be of any suitable thermo-kinetically heated type known in the art. Such mixers, like the GELIMAT line of mixers manufactured by Draiswerke, Inc. of Mahwah, N.J., include a rotor element which rotates at high speeds within a mixing, or compounding, chamber. A plurality of mixing members—preferably in the form of blade elements project radially from the rotor element to mix and masticate the materials introduced into the chamber within and against the chamber walls. The thermo-kinetic effect derives from the high speed rotation of the rotor and blade elements and the heat-generating frictional contact of the material against the blade elements and chamber walls caused thereby. This not only obviates the need for any extraneous external heating means, it optimizes the degree of simultaneous heating and mixing to such extent that substantial homogeneity is readily attained in the mixture. Accordingly, the mixture's constituent materials are evenly enough dispersed to be found at consistent respective concentrations throughout its volume.

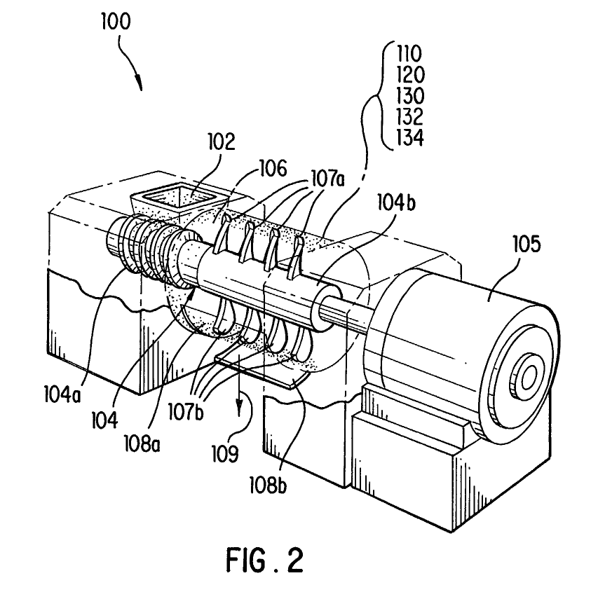

Referring to FIG. 2, there is shown an illustrative diagram of an exemplary high speed mixer 100 that may be employed in system 10. The mixer shown is generally of the GELIMAT type described in preceding paragraphs. The mixer includes a feed receptacle 102 through which comminuted rubber composition 110 is introduced. Feed receptacle 102 leads to a screw feed portion 104a of a main shaft member 104 driven by a drive mechanism 105. Feed screw 104a advances the components introduced through feed receptacle 102 into a mixing chamber 106. The intermediate portion of main shaft 104 disposed within mixing chamber 106 forms a rotor portion 104b from which a plurality of blade-like mixing members 107a, 107b radially project.

One or more of the plasticizing agent and additive compositions 120, 130, 132, 134 may also be introduced through feed receptacle 102; however, at least plasticizing agent composition 102 is preferably introduced directly into mixing chamber 106 through a separate direct connection (not shown). Mixing chamber 106 is formed with a discharge opening 108a which is selectively closed by a discharge door 108b. Once a batch of material is completely mixed, discharge door 108b is opened, and the batch is discharged through opening 108a, as indicated by directional arrow 109.

The first set of mixing members 107a are disposed as shown pitched at a certain predetermined angle suitable for the given application. The second set of mixing members 107b are preferably disposed with respect to the first set of mixing members 107a in complementary manner, pitched at an angle opposite to that of mixing members 107a. Mixing members 107a, 107b are so configured and disposed to optimally control the manner in which the mixture components are agitated within mixing chamber 106. The configuration and positioning of mixing members 107a, 107b may be suitably altered in other applications and embodiments.

During typical operation, high speed mixer 100 is typically operated to rotate its main shaft member 104 at approximately 1200-1700 RPM. With a mixing chamber 106 capacity of 25 liters, sustained rotation of main shaft member 104 for a 15 second time period generates thermo-kinetic heating of the mixture to a temperature between approximately 170°-240° F.

The operation of system 10 occurs preferably on a batch-processing basis. Referring back to FIG. 1, upon thermo-kinetically heating the mixture within high speed mixer 100, the substantially homogenous intermediate mixture of compositions 110, 120, 130, 132, 134 forms a batch of substance having a tacky granular consistency which is discharged into a hold hopper 140, and temporarily staged there for subsequent passage into a primary hopper/blender 200. System 10 preferably operates to maintain in hold hopper 140 two batches of the intermediate mixture composition discharged from high speed mixer 100. As a batch is removed from hold hopper 140 for passage to primary hopper/blender 200, another batch is mixed and discharged by high speed mixer 100 into hopper 140 to replace the removed batch. Hold hopper 140 includes a plurality of augers or other such means which operate to preserve the tacky granular consistency of the intermediate mixture composition staged therein.

Preferably, the introduction of compositions 110, 120, 130, 132, 134 into high speed mixer 100, the actuation of high speed mixer 100, and the discharge of the intermediate mixture composition into hold hopper 140 are automatically controlled—as are the other processing steps carried out by system 10 further downstream. Automatic control is provided by a programmable controller (not shown) which receives condition-sensing signals from a plurality of level probes disposed at various points in system 10. Control is maintained such that the introduction of the designated compositions into and their mixture within high speed mixer 100 is automatically actuated when the level of material staged within hold hopper 140 is sensed to have dropped below two batches in quantity. Once it is sensed that the staged quantity has again reached two batches, this operation is stopped, and high speed mixer 100 is kept idle until a sufficient drop in material level and hold hopper 140 is again sensed.

In the embodiment shown, the intermediate mixture composition staged at hold hopper 140 is transported to primary hopper/blender 200 via a vacuum-driven connection 142. Vacuum-driven connection 142 provides a quick and efficient means of transport, whereby the intermediate mixture composition from hold hopper 140 is effectively ‘sucked’ up and into primary hopper/blender 200 which, in typical applications, may be elevated in position to enable gravity-assisted transport of material to and between subsequent processing operations further downstream.

Primary hopper/blender 200 also includes a blending auger or some other agitating mechanism to provide continual blending of its contents. This preserves the tacky granular state of the intermediate mixture composition, preventing the granules from combining into masticated clumps. The intermediate mixture composition is passed from primary hopper/blender 200 to a secondary hopper/blender preferably by simple gravity assist. Within secondary hopper/blender 300, the intermediate mixture composition is again continually blended via an auger or other such mechanism.

At this secondary hopper/blender 300, one or more secondary additive compositions, such as fillers 310 and plasticizers 312, may be introduced and blended with the intermediate mixture composition. Secondary additive compositions 310, 312 introduced at this point are of the type whose contribution to, or effect upon, the material properties desired in the intermediate mixture composition is not critical. Hence, the homogeneity of their incorporation into the mixture composition is likewise not critical. Examples of such secondary additive compositions include wood fibers, glass, Fiberglass, and other filler materials, and one or more suitable plasticizers to facilitate their incorporation into the intermediate mixture composition.

The intermediate mixture composition passes, then, from secondary hopper/blender 300 to a side draft feeder 400 to be fed thereby into an extruder 500. One or more plastic compositions 410 are also fed into extruder 500 for combination with the intermediate mixture composition fed by side draft feeder 400. Extruder 500 may be of any suitable type known in the art capable of adequately agitating, mixing, and further heating the plastic and intermediate mixture compositions, then compressing the combined mixture to a masticated mass having a predetermined sectional contour.

Preferably, plastic composition 410 includes in comminuted form a scrapped or recycled thermoplastic material, and extruder 500 is of a type having a plurality of sequentially disposed heating zones, or stages. Given that the material properties characterizing plastic composition 410 are different from those characterizing the intermediate mixture composition, the degree of heating during transport within extruder 500 required for plastic composition 410 is different from that required for the intermediate mixture composition. Moreover, extruder 500 typically employs a screw-type feed member which invariably causes a degree of shear in the transported material. The extent to which they may be safely subjected to such shear is also different for the two compositions. The two compositions are, therefore, introduced at different heating zones of extruder 500, the point at which the intermediate mixture composition is fed being disposed downstream relative to the point at which plastic composition 410 is fed. The precise feed points, of course, will vary depending on the two compositions' particular material properties and the extruder's particular specifications for a given application.

In the embodiment shown, extruder 500 is of a type known in the art employing twin parallel feed screw mechanisms for agitation and transport of the fed compositions. The twin feed screw configuration, extending in parallel and in open communication one with the other, yield a more efficient mixing of the compositions than a single feed screw configuration, while minimizing their residual shear.

The sequentially disposed heating zones, or stages, of extruder 500 are followed by a final die stage 510. Die stage 510 defines an extrusion opening of a predetermined shape, such that as the combined compositions are forcibly passed through that opening, a doughy, masticated second intermediate mixture composition sectionally contoured to that predetermined shape results. In the embodiment shown a generally round opening shape is employed. Any other suitable opening shape may be employed in other embodiments depending on the requirements of the intended application.

The second intermediate mixture composition is extruded at a temperature sufficiently high enough to cohesively maintain its doughy, masticated form. In typical applications of system 10, the second intermediate mixture composition is extruded at a temperature ranging between approximately 265°-500°. This ensures that the plastic constituents of the second intermediate mixture composition are sufficiently melted and combined with the rubber and other constituents of that mixture composition.

Pelletizer 600 may be formed by any suitable device known in the art for cooling and cutting the doughy second intermediate mixture composition into a pelletized configuration. Preferably, pelletizer 600 is one which presses the received second intermediate mixture composition through a plurality of minute orifices to form a plurality of strands which are then subjected to water-submerged cutting. Concurrent cooling and cutting of the material into a plurality of pellets is thus effected.

To ensure adequate removal of heat, water provided from a source 610 is run through pelletizer 600 in regulated manner. The cooled and pelletized form of the second intermediate mixture composition is conveyed by the running water into a first dryer centrifuge 700, at which point it is cooled and solidified into a relatively hard bead or pellet configuration. First dryer centrifuge 700 operates upon the second intermediate mixture composition's pellets to reduce their moisture content, preferably to an approximate level of at least 2%. From there, the pellets are preferably air blown into a second dryer centrifuge 800 which then operates to further reduce the pellets' moisture content, preferably down to an approximate level of at least 0.05%.

Other suitable means known in the art for cooling and drying the second intermediate mixture composition may be employed in other applications, as may other suitable means for cutting the composition to a particularly chosen form. In the embodiment shown, the disclosed pelletizing and drying measures are employed not only to provide ease of storage, handling, and subsequent use, but also to simplify and optimize the cooling and drying processes. Pelletizer 600, first and second centrifuge dryers 700, 800, as well as fine separator sieve 900 (described in following paragraphs) may be of such types as those made commercially available by TDS, Inc. of Vancouver, British Columbia, Canada.

The second intermediate mixture composition formed in the embodiment shown tends in typical applications to exhibit hygroscopic properties. That is, the composition tends to draw in and absorb moisture. To compensate for this effect, the water run through pelletizer 600 is preferably preheated to a predetermined level, set for instance between approximately 180°-190° F., so as to minimize the induction of water into the composition's pellets.

The drying process is enhanced at second dryer centrifuge 800 preferably by drawing a vacuum therein. The vacuum may be generated using motor-driven blowers (not shown) to generate the negative pressure necessary to draw a vacuum at a level, for example, under 0.1 Hg. The second centrifuge drying process is carried out, then, under that vacuum.

The dried second intermediate mixture composition pellets are thereafter passed to a fine separator sieve 900 which serves essentially to separate the pellets based upon size (relative to a certain preset threshold). This ensures a degree of uniformity in the dimension and configuration of the elastomeric compound pellets stored in storage unit 1000. In typical applications of the embodiment shown, fine separator sieve 900 effects sufficient ‘filtering’ to yield a plurality of elastomeric compound pellets having a substantially uniform size of, for example, 1/8 inches in diametric dimension.

The elastomeric compound pellets thus formed may be stored, then later used as a stock material in various other processes to form elastomeric goods and structures. Though the elastomeric compound may be formed with other configurations in alternate embodiments, the pelletized, or granular, configuration tends in many applications to provide such practical advantages as easier handling, manipulation, and packaging over alternate configurations. The present invention is not limited to any particular configuration.

As mentioned in preceding paragraphs, the disclosed method and system yield a level of speed and efficiency heretofore unseen in the art to fabricate elastomeric compounds whose core constituent materials are mixed with substantial homogeneity. Such is the degree of speed and efficiency realized in accordance with the present invention that in an exemplary application employing a high speed mixer 100 having a 25 liter mixing chamber capacity (11 lbs. of comminuted rubber composition 10 per batch), system 10 readily operates to form elastomeric compounds of substantially homogenous mixture at a rate that consumes approximately 1400 lbs. per hour of comminuted rubber composition 110. If necessary, system 10 in that same application may safely operate to consume comminuted rubber composition 10 at a rate as high as 2400 lbs. per hour.

Although this invention has been described in connection with specific forms and embodiments thereof, it will be appreciated that various modifications other than those discussed above may be resorted to without departing from the spirit or scope of the invention. For example, equivalent elements may be substituted for those specifically shown and described, certain features may be used independently of other features, and in certain cases, particular combinations of processing steps may be reversed or interposed, all without departing from the spirit or scope of the invention as defined in the appended claims.

What is claimed is:

1. A method of fabricating elastomeric compounds comprising the steps of:
a. establishing a thermo-kinetically heated high speed mixer;
b. introducing into said high speed mixer in predetermined quantities a comminuted rubber composition, a plasticizing agent composition, and at least one additive composition;
c. simultaneously mixing and thermo-kinetically heating said comminuted rubber, plasticising agent, and additive compositions in said high speed mixer for a predetermined residence time period to form a first intermediate mixture composition, said first intermediate mixture composition containing a substantially homogeneous mixture of said comminuted rubber, plasticizing agent, and additive compositions;
d. introducing said first intermediate mixture composition and a plastic composition into a heated multi-stage extruder to form a second intermediate mixture composition; and,
e. drying said second intermediate mixture composition to form an elastomeric compound.

2. The method of fabricating elastomeric compounds as recited in claim 1 wherein a plurality of said additive compositions are introduced into said high speed mixer in step b, said additive compositions including a filler composition, an antioxidant composition, and an accelerator composition.

3. The method of fabricating elastomeric compounds as recited in claim 2 wherein said filler, antioxidant, and accelerator compositions are introduced in respective approximating weight percentage ranges of 1%-25%, 0.25%-1%, and 0.01%-1%.

4. The method of fabricating elastomeric compounds as recited in claim 1 wherein said comminuted rubber, plasticizing agent, and additive compositions are introduced into said high speed mixer in substantially contemporaneous manner.

5. The method of fabricating elastomeric compounds as recited in claim 1 further comprising between steps c and d the step of blending into said first intermediate mixture composition at least one auxiliary composition.

6. The method of fabricating elastomeric compounds as recited in claim 5 wherein an auxiliary filler composition and an auxiliary plasticizer composition are blended into said first intermediate mixture composition.

7. The method of fabricating elastomeric compounds as recited in claim 1 further comprising before step e the step of pelletizing said second intermediate mixture composition.

8. The method of fabricating elastomeric compounds as recited in claim 1 wherein said thermoplastic composition in step d is introduced into said extruder at a preselected stage thereof, and said first intermediate mixture composition is introduced at a stage of said extruder disposed upstream relative to said preselected stage.

9. The method of fabricating elastomeric compounds as recited in claim 1 wherein said plasticising agent composition is preheated to at least an approximate temperature of 70° C. prior to introduction into said high speed mixer.

10. The method of fabricating elastomeric compounds as recited in claim 1 wherein said first intermediate mixture composition is formed with a thermo-kinetically heated temperature within the approximate range of 170°-240° F.

11. The method of fabricating elastomeric compounds as recited in claim 10 wherein said predetermined residence time period is less than 20 seconds.

12. The method of fabricating elastomeric stock materials as recited in claim 10 wherein said additive composition is selected from the group consisting of: filler, antioxidant, accelerator, plasticiser, ultraviolet inhibitor.

13. A method of fabricating elastomeric stock materials comprising the steps of:
a. establishing a thermo-kinetically heated high speed mixer;
b. contemporaneously introducing into said high speed mixer in predetermined batch quantities a comminuted rubber composition, a plasticizing agent composition, and a plurality of additive compositions, said plasticising agent composition being preheated to a temperature of approximately 70° C. prior to introduction into said high speed mixer, said additive compositions including: a filler composition, an antioxidant composition, and an accelerator composition;
c. simultaneously mixing and thermo-kinetically heating said comminuted rubber, plasticising agent, and additive compositions in said high speed mixer for a predetermined residence time period to form a first intermediate mixture composition, said first intermediate mixture composition containing a substantially homogeneous mixture of said comminuted rubber, plasticizing agent, and auxiliary compositions, said first intermediate mixture composition having a thermo-kinetically heated temperature within the approximate range of 170°-240° F.;
d. introducing said first intermediate mixture composition and a thermoplastic composition into a heated multi-stage extruder to form a second intermediate mixture composition extrusively shaped to a predetermined sectional contour; and,
e. pelletizing and drying said second intermediate mixture composition to form an elastomeric stock material.

14. The method of fabricating elastomeric stock materials as recited in claim 13 wherein said filler, antioxidant, and accelerator compositions are introduced in respective approximating weight percentage ranges of 1%-25%, 0.25%-1%, and 0.01%-1%.

15. The method of fabricating elastomeric stock materials as recited in claim 13 wherein said plasticising agent composition is preheated to at least an approximate temperature of 70° C. prior to introduction into said high speed mixer.

16. The method of fabricating elastomeric stock materials as recited in claim 13 wherein said predetermined residence time period is less than 20 seconds.

17. A system for fabricating elastomeric compounds comprising:
a. a high speed mixer operable to simultaneously mix and thermo-kinetically heat a plurality of compositions introduced therein, said high speed mixer including a housing defining a mixing chamber, and an angularly displaceable shaft coupled to said housing to extend axially in said mixing chamber, and a plurality of mixing members coupled to said shaft to extend radially therefrom;
b. sources coupled to said high speed mixer for respectively introducing into said high speed mixer in substantially contemporaneous manner predetermined quantities of a comminuted rubber composition, a plasticizing agent composition, and at least one additive composition, whereby said high speed mixer is operable to generate a first intermediate mixture composition containing a substantially homogeneous mixture of said comminuted rubber, plasticizing agent, and auxiliary compositions;
c. a heated multi-stage extruder having an angularly displaceable screw feed member extending axially through a plurality of sequentially disposed heating stages;
d. a source operably coupled to said extruder for feeding a plastic composition into said extruder at a preselected one of said heating stages thereof;
e. a side draft feeder operably coupled to said extruder for feeding said first intermediate mixture composition at one said heating stage of said extruder disposed upstream relative to said preselected heating stage, whereby said extruder is operable to generates a second intermediate mixture composition; and,
f. a pelletizer operably coupled to said extruder for cooling and cutting said second intermediate mixture composition into a pelletized configuration.

18. The system for fabricating elastomeric compounds as recited in claim 17 wherein said high speed mixer is operable to thermo-kinetically heat said first intermediate mixture composition to a temperature within the approximate range of 1700-2400° F.

19. The system for fabricating elastomeric compounds as recited in claim 17 further comprising at least one centrifuge dryer operably coupled to said pelletizer for removing moisture from said pelletized second intermediate mixture composition.

20. The system for fabricating elastomeric compounds as recited in claim 17 wherein said high speed mixer includes first and second sets of said mixing members, said first set of mixing members forming a plurality of blades disposed at a first predetermined pitch angle, said second set of mixing members forming a plurality of blades disposed at a second predetermined pitch angle opposite in value from said first predetermined pitch angle.
